(19) United States
(12) Patent Application Publication
(10) Pub. No.: US 2026/0204255 A1
(43) Pub. Date: Jul. 16, 2026

(54) SPEECH RECOGNITION SYSTEM EMPLOYING SPECULATIVE EXECUTION

(71) Applicant: SoundHound AI IP, LLC, Santa Clara, CA (US)

(72) Inventor: Quinn Harris, Flower Mound, TX (US)

(73) Assignee: SoundHound AI IP, LLC, Santa Clara, CA (US)

(21) Appl. No.: 19/017,320

(22) Filed: Jan. 10, 2025

(51) Int. Cl. G10L 15/22; G10L 15/26; G10L 25/78

(52) U.S. Cl. CPC G10L 15/22; G10L 15/26; G10L 25/78

(57) ABSTRACT

A speculative execution system and method receives and processes audio data in real time. As a user speaks, the system begins generating and outputting speculative responses based on partial transcripts. The system continuously re-evaluates and updates its outputted speculative response as new utterances are received, adapting to changes in meaning as the complete utterance unfolds. This process continues until it is determined that the speaker has completed their utterance, at which point the system reaches a final, non-speculative complete and accurate response. Such a speculative execution system optimizes both speed and accuracy by balancing speculative intermediate responses with a final review process that accounts for the entire utterance.

### FIELD

The technology relates to voice recognition systems and, more particularly, to a speculative execution system for voice recognition that processes utterances and provides real-time speculative responses which get continuously re-evaluated and updated as new utterances are received, adapting to changes in meaning as the complete utterance unfolds.

### BACKGROUND

Conventional voice recognition systems typically transcribe and process utterances, and provide responses once a speaker has finished. These systems also recognize “turn-taking,” where they wait for the user to pause before generating a response. This approach can lead to delays in interaction, potentially reducing the perceived intuitiveness of the system and increasing the interaction duration.

While responding more quickly would enhance user experience, it presents challenges. If a system were to respond before the user finished speaking, subsequent spoken words might alter the meaning of the previously transcribed text. Current systems are not equipped to handle this scenario effectively.

### DESCRIPTION OF THE DRAWINGS

FIG. 1 is a schematic representation of a speculative execution system according to embodiments of the present technology.

FIG. 2 is a schematic representation of a speculative execution system according to alternative embodiments of the present technology.

FIG. 3 is a first flowchart showing operation of a speculative execution server according to embodiments of the present technology.

FIG. 4 is an illustration of the speculative execution engine receiving speech from a user and providing a speculative response in real time according to embodiments of the present technology.

FIG. 5 is an illustration of the speculative execution engine receiving additional speech from a user and providing a revised speculative response in real time according to embodiments of the present technology.

FIG. 6 is an illustration of the speculative execution engine receiving additional speech from a user and providing a further revised speculative response in real time according to embodiments of the present technology.

FIG. 7 is an illustration of the speculative execution engine receiving additional speech from a user and providing a final response in real time according to embodiments of the present technology.

FIG. 8 is a flowchart showing operation of the speculative execution server to prompt a user for additional information.

FIG. 9 is an illustration of the speculative execution engine receiving speech from a user in response to the prompt and providing a speculative response in real time according to embodiments of the present technology.

FIG. 10 is an illustration of the speculative execution engine receiving speech from a user in response to the prompt and providing a final response in real time according to embodiments of the present technology.

FIG. 11 is a schematic block diagram of a computing environment according to embodiments of the present technology.

### DETAILED DESCRIPTION

The present technology will now be described with reference to the figures, which in general relate to a speculative execution system and method which receives and processes audio data in real time. As a user speaks, the system begins generating and outputting speculative responses based on partial transcripts. The system continuously re-evaluates and updates its outputted speculative response as additional spoken words are transcribed, adapting to changes in meaning as the complete utterance unfolds. This process continues until it is determined that the speaker has completed their utterance, at which point the system reaches a final, non-speculative complete and accurate response.

Such a speculative execution system optimizes both speed and accuracy by balancing speculative intermediate responses with a final review process that accounts for the entire utterance.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

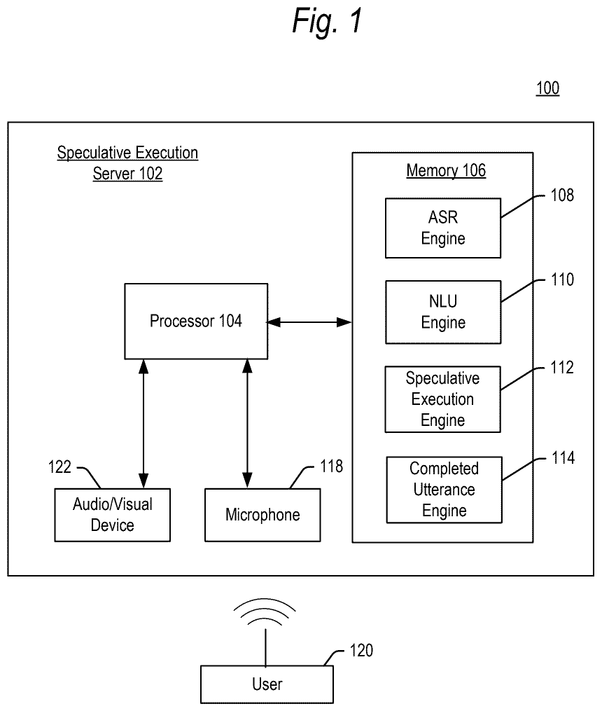

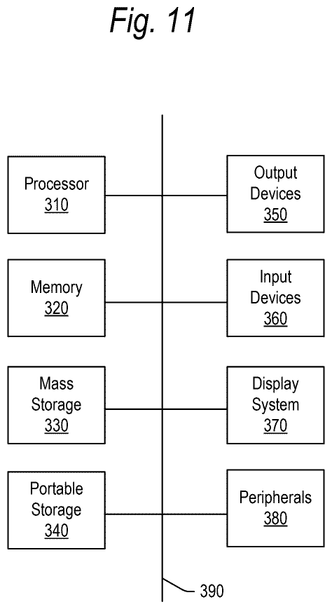

FIG. 1 is a schematic block diagram of a sample speculative execution architecture 100 for implementing the present technology. Architecture 100 may include a server owned, controlled or implemented by a speculative execution service provider, referred to herein as speculative execution server 102. In further embodiments, server 102 may be comprised of multiple servers, collocated or otherwise. A more detailed explanation of a sample server 102 is described below with reference to FIG. 11, but in general, server 102 may include a processor 104 configured to control the operations of server 102, as well as facilitate communications between various components within server 102. The processor 104 may include a standardized processor, a specialized processor, a microprocessor, AI processor, GPU or the like that may execute instructions for controlling server 102.

The server 102 may further include a memory 106 that may store algorithms that may be executed by the processor 104. According to an example embodiment, the memory 106 may include RAM, ROM, cache, flash memory, a hard disk, and/or any other suitable storage component. As shown in FIG. 1, in one embodiment, the memory 106 may be a separate component in communication with the processor 104, but the memory 106 may be integrated into the processor 104 in further embodiments.

Memory 106 may store various software application programs executed by the processor 104 for controlling the operation of the server 102. Such application programs may for example include an automatic speech recognition (ASR) engine 108 and a natural language understanding (NLU) engine 110 for recognizing and interpreting utterances. Memory 106 may further include a speculative execution engine 112 for generating intermediate (speculative) and final responses to spoken utterances. Memory 106 may further include a completed utterance engine 114 for determining when a user has stopped speaking. Each of the engines 108, 110, 112 and 114 are explained in greater detail below. Memory 106 may store additional algorithms in further embodiments.

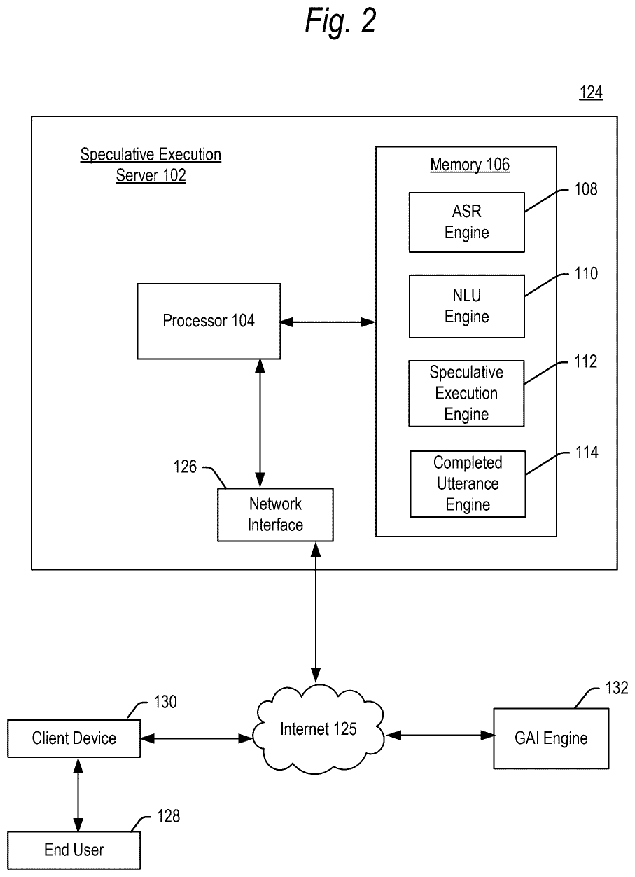

The speculative execution environment 100 of FIG. 2 is one where users speak with the server 102, and server 102 responds with speech and/or text. A common such environment may be a restaurant (or other service provider facility) drive-through ordering system. In such environments, the server 102 may further include a microphone 118 for receiving orders from users 120, and an audio/visual device 122 for audibly and/or visibly outputting confirmation of the order as well as other information. In embodiments, the audio/visual device 122 may comprise an order confirmation board, or OCB, for displaying order confirmation and other information as explained below. The server 102 may include additional components for example as described below with respect to FIG. 11.

While embodiments of the present technology are described with respect to an ordering system used at restaurant drive-through locations, it is understood that the present technology may also or alternatively be used indoors, for example inside a restaurant or other service provider facility. In such embodiments, a user would interact with the speculative execution server 102 of an automated order taking system, for example while seated at a table or while ordering or conversing at a counter.

The speculative execution system may also be used in at a variety of service provider facilities other than restaurants. These additional interactive service provider facilities include but are not limited to self-service kiosks at airports, grocery store checkout stations, bank ATMs and service windows, hotel check-in and assistance kiosks, pharmacy or retail store kiosks, public transportation kiosks, healthcare facilities and movie theaters.

While embodiments of the present technology are explained in general with respect to in-person ordering or interactive systems, it is understood that users may order from, or otherwise interact with, the speculative execution server 102 while being remote from the server 102. Such an embodiment is shown in FIG. 2. In this embodiment, a user may interact with the server 102 via the Internet 125 or other networked connection. Here, the speculative execution server 102 may include communications circuitry such as a network interface 126 for communicating with the Internet 125. In this embodiment, the speculative execution server 102 may interact with a user 128 through their client device 130 via the Internet 125 or other networked connection. The user may interact with the speculative execution server 102 by transmitting audio through the device, and may receive speculative results displayed on a display of the device 130 which gets updated in real time by the speculative execution server as the user continues to speak.

FIG. 2 further shows a generative artificial intelligence (GAI) engine 132, for example a large language model which may assist functionality of the speculative execution server 102. For example, the GAI engine 132 may assist the ASR and/or NLU engines 108 and 110 in recognizing and interpreting utterances, determining if the user's utterance is complete, and may also assist the speculative execution engine 112 in generating intermediate (speculative) and/or final responses. In embodiments, the processor 104 may be in communication with a GAI engine 132 via the Internet 125. In further embodiments, the processor itself may be an AI processor, for example having the GAI engine 132 integrated into the processor 104 of the speculative execution server 102. As such, the GAI engine 132 may also operate with the speculative execution environment 100 shown in FIG. 1.

GAI engine 132 receives an input, or prompt, and uses models and algorithms to generate an output including new, original content based on a given dataset on which engine 132 is trained. GAI engine 132 may be an existing generative neural network, such as GPT-3, GPT-4, or other known models. These models have been trained on extensive datasets and possess the ability to generate coherent and contextually relevant text based on provided input. In embodiments, the GAI engine 132 may be trained or tuned specifically for the environment of the speculative execution server 102. Thus, where the server 102 is used as an ordering system for restaurants or other service industry facilities, the GAI engine 132 may be trained for such restaurants or service industries.

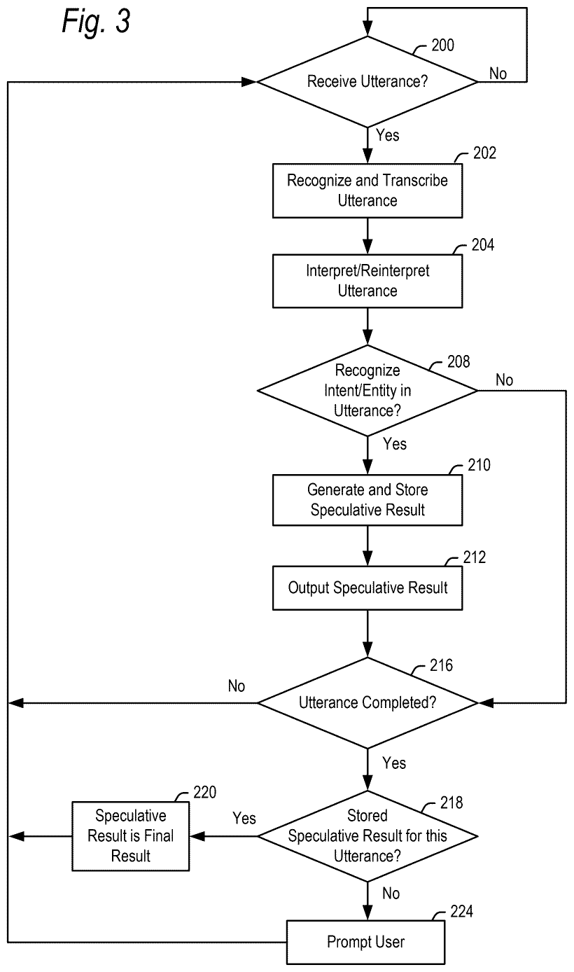

FIG. 3 is a flowchart showing the operation of the speculative execution server 102. In step 200, the speculative execution server 102 monitors whether a spoken utterance is received. If so, the uttered speech is recognized and transcribed into text in step 202 by ASR engine 108. Speech recognition and transcription by ASR engine 108 may be a known process, but in examples, the step involves processing received speech by extracting acoustic features of the received speech using for example Fourier transforms and Mel filter bank coefficients computed on the Fourier transforms. The acoustic features may then be matched to phonemes, using for example Hidden Markov Models (HMMs) or neural networks such as GAI engine 132. A language model then sequences these phonemes into words by using statistical probabilities, taking into account the likelihood of certain word combinations based on the structure of the language. Examples of such language models include N-gram language models and neural network language models. Finally, the system outputs the recognized words as transcribed text.

The output of the ASR engine 108 may then be input to the NLU engine 110 to determine a meaning of the recognized words in step 204. In general, the NLU engine 110 may operate by processing the recognized text to extract its meaning for example by breaking the text into individual words or phrases (tokenization). Then, it uses techniques such as part-of-speech tagging to identify grammatical roles (e.g., nouns, verbs) and named entity recognition to detect specific entities (e.g., names, locations). It may also apply syntactic parsing to understand the structure of the sentence and semantic analysis to infer the meaning or intent behind the words, often based on pre-trained models or rules. The NLU engine 110 may interpret the intent and entities in the text to derive a structured representation of meaning, which intents and entities are used by the speculative execution engine 112 as explained below.

In embodiments, the NLU engine 110 may be generalized for use in any environment. In further embodiments, the NLU engine 110 may be trained on the specific environment in which the speculative execution engine 112 operates. For example, where engine 112 is used as an ordering system in restaurant drive-throughs, the NLU engine may be trained to recognize each specific menu item, as well as speech related to food and beverage ordering.

It is a feature of the present technology that the ASR and NLU engines do not wait until a user stops speaking to generate recognized intents and entities. Instead, the ASR engine continuously evaluates the input audio to generate additional transcribed words and update the transcription, and the NLU engine continuously processes the updated transcription in real time to determine if a partial utterance has meaningful content. If so, the system generates an intermediate, speculative response as explained below.

In step 208, the server 102 checks whether the NLU generated any recognizable intents and/or entities from the input utterance. Intents may for example represent the purpose or goal behind an utterance, capturing the intended meaning or action. Thus, for example if a user utters the words:
“I want a coffee”
   the intent would be ordering a beverage. The entities are specific pieces of extracted information that provide context or details. Thus, in the above example, the entity would be coffee.

If no intent or entity is detected in step 208, the flow checks whether an utterance is completed in step 216 as explained below. On the other hand, if an intent and entity is detected in step 208, the speculative execution engine 112 generates and stores a speculative response in step 210, and outputs the speculative response to the audio/visual device 122 (FIG. 1) in step 212. The speculative execution engine 112 is trained to generate responses to given intents and entities. The speculative execution engine 112 may be trained for this purpose algorithmically, having rules defining responses for given intents and entities. Alternatively or additionally, the speculative execution engine 112 may operate using GAI engine 132 integrated into processor 104.

Thus, in the above example “I want a coffee,” the speculative execution engine may generate a visual confirmation of the order on the audio/visual device 122. This action may be considered the execution portion of the speculative execution engine. That is, the execution portion is trained to generate a given response to a given set of intent and entity inputs.

The engine 112 is referred to as a speculative execution engine in that, the engine 112 preferably generates responses in real time, possibly before the user is finished speaking. These responses are referred to herein as being intermediate and speculative, as the response may be replaced when later additional portions of the user's utterance are received and analyzed. This feature is explained in greater detail below. While the speculative execution engine 112 and NLU engine 110 are described as separate software engines, in further embodiments, these two engines may be integrated together.

In step 216, the completed utterance engine 114 determines whether a user has finished speaking. In conventional, so-called turn-taking systems, this is when the system determines the speaker's turn has ended, and it would then generate a response. However, as explained herein, the present system generates responses before the user finishes speaking, and updates those responses as additional speech changes the meaning of what user previously said. Again, this feature is explained in greater detail below. However, in step 216, the completed utterance engine 114 determines whether a user has finished speaking. If not, the server 102 returns to step 200 to receive the next portions of the utterance.

If, on the other hand, it is determined in step 216 that a user has stopped speaking, then then either the last stored speculative result (if there is one) becomes the final result for the completed utterance or the transcript provided by the ASR engine that is determined to be the final transcript is evaluated by the NLU engine to become the final result to supersede the last speculative result. Thus, in step 218, the server 102 checks whether there is a stored speculative result for the current utterance, and if so, that speculative result may be used as the final result in step 220. If, on the other hand, there is no stored speculative result or a determined final transcript for the current utterance in step 218, that means the server 102 was not able to recognize any discernable speech in the user's utterance, and the user may be prompted in step 224 to repeat his or her speech.

The completed utterance engine 114 may use a wide variety of techniques to determine whether a user has finished speaking. One easy technique is to detect a pause in the user speech, for example of 1-3 seconds. However, there may be a wide variety of other techniques, including cadence, context and the interpretation of the utterance to that point. Cadence can be used to infer the end of speech because changes in the speaker's tone or inflection, such as a falling intonation at the end of a sentence, can indicate completion. Context can also indicate the end of speech. For example, where a user is prompted to answer a yes/no question, receipt of a yes or no can be an indication that the user is done speaking. Meaning of the speech can also be used to infer the end of speech. For example, where a user finishes their order with “that's it,” or “we don't want anything else,” or other similar phrases indicating an order has been completed, this can be interpreted as the end of speech. Furthermore, a GAI engine (such as a large language model) may be utilized to evaluate the likelihood that an utterance is complete. One or more of these techniques may be used in combination. Moreover, these techniques are not intended to be limiting, and it is understood that a variety of other techniques may be used by the completed utterance engine 114 to determine when a user has stopped speaking.

In certain implementations, the system applies the results of the NLU engine or other language models to transform a structured conversation state, such as a ticket or cart, into a new state that reflects the user's intent and entity results. This transformed conversation state is used as input for subsequent execution rounds, ensuring that the system adapts dynamically to evolving utterances. Notably, speculative execution results are used temporarily to generate intermediate outputs, such as updates to an order confirmation board, but they do not persist or influence future execution cycles unless finalized.

Once the system determines that the user's utterance is complete, the final results are applied to the conversation state, replacing any speculative outputs. This approach ensures that the system balances the flexibility of speculative execution with the accuracy of finalized responses, allowing for seamless real-time interaction while maintaining a consistent and reliable conversation state. Furthermore, additional processing strategies may be applied to tailor the handling of speculative versus finalized results, optimizing the system's performance for both real-time feedback and accuracy in completing user requests.

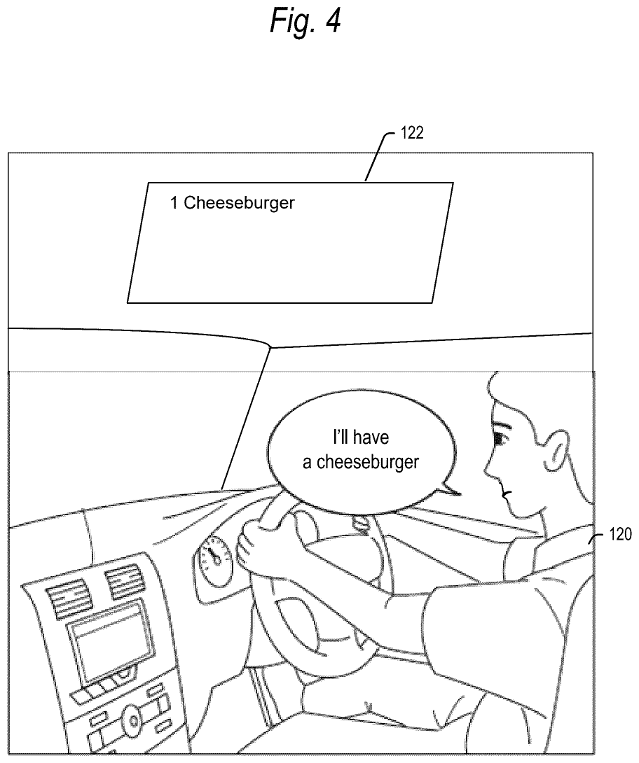

An example use-case of the operation of the speculative execution server 102 will now be explained with reference to the illustrations of FIGS. 4-7. In this example, a user 120 is at a drive-through ordering location at a restaurant. The ordering location includes an audio/visual device 122 in the form of an order confirmation board (OCB) 122 located at an easily viewable position outside of the user's car. The OCB 122 displays and confirms the user's order. In further embodiments, it is conceivable that OCB 122 be omitted, and the order be displayed on a display 150 inside the user's car, having a Bluetooth or other networked connection to the server 102 at the restaurant, or on the user's smartphone.

In this example, the user begins speaking by saying:
“I'll have a cheeseburger”
   The user does not appear to be finished speaking at this point. However, in accordance with aspects of the present technology, the server 102 runs through the above-described steps, recognizes the order, and provides a speculative, intermediate result in the form of a confirming display item on OCB 122:
“1 Cheeseburger.”

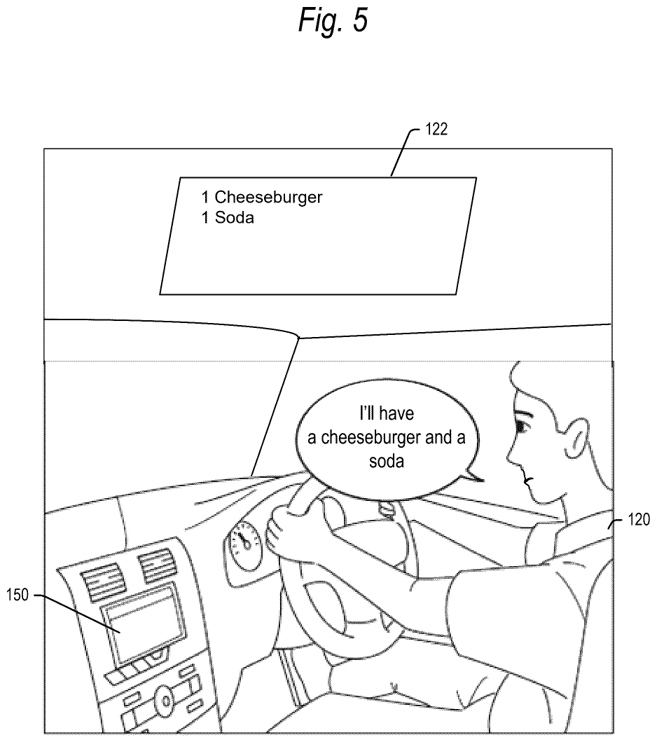

FIG. 5 shows that user has continued speaking. After saying he'll have a cheeseburger, the user continues that he'll have a soda. The server 102 runs through the above-described steps, re-evaluates the order, and provides a further speculative, intermediate result in the form of a confirming display item on OCB 122:
“1 Cheeseburger
1 Soda.”

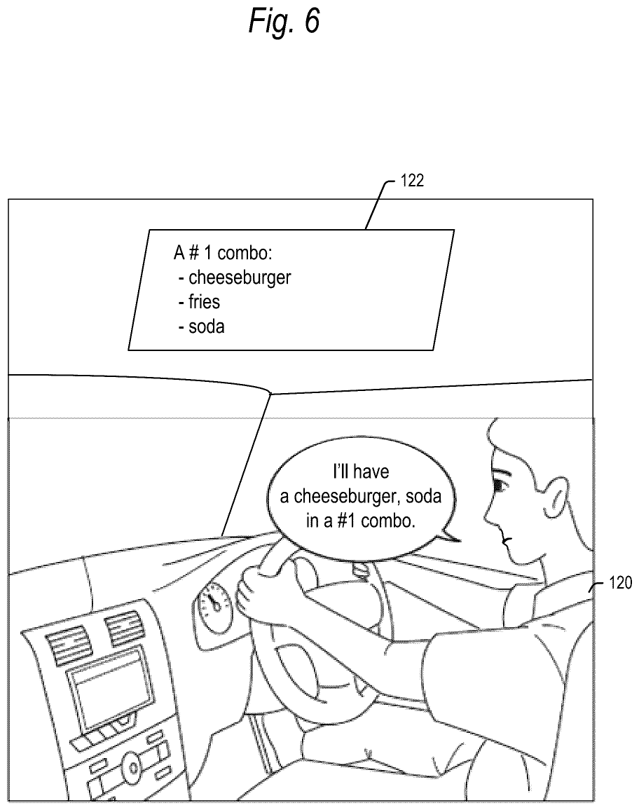

FIG. 6 shows that user has continued speaking. After saying he'll have a cheeseburger and a soda, the user continues that he'll have those as part of a “#1 combo.” The server 102 runs through the above-described steps, re-evaluates the order, and provides a further speculative, intermediate result. In this case, the indication that the cheeseburger and soda are part of a combo has altered the meaning of his order. As such, the speculative result at this point is replaced from that of its previous state. The confirming order generated by the speculative execution engine 112 rearranges his previously displayed confirmation to now show the order is a combination order including the ordered cheeseburger and soda. The engine 112 in this example further recognizes from its training that the #1 combo includes french fries. Thus, the confirming display item on OCB 122 shows:
“A #1 combo:
   cheeseburger
   fries
   soda.”

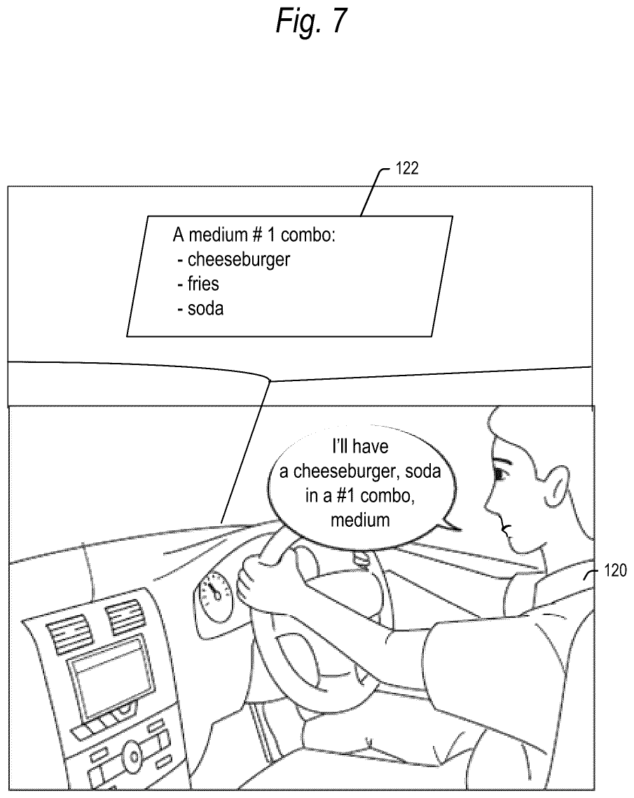

FIG. 7 shows that user has continued speaking. After saying he'll have a cheeseburger and a soda in a #1 combo, the user continues that the combo will be “medium” sized. The server 102 runs through the above-described steps, re-evaluates the order, and provides a further speculative, intermediate result. In this case, the indication that the order is to be medium size has altered, or further clarified, the meaning of his order. As such, the speculative result at this point replaces that of its previous state. The confirming order generated by the speculative execution engine 112 revises his previously displayed confirmation to now show the order is a medium combo including the ordered cheeseburger and soda. Thus, the confirming display item on OCB 122 shows:
“A medium #1 combo:
   cheeseburger
   fries
   soda.”

At this point, the user 120 stops speaking and the completed utterance engine 114 determines that the utterance (the user's order) is completed. Thus, the speculative result shown in FIG. 7 becomes the final result. It is noted that, although the result is final, this does not mean that the user cannot go back and edit that result (in this case, the user's order). However, that edit (to change, delete, add to or otherwise amend the order) would be considered part of a subsequent utterance, with the effect of altering the result of a previous utterance.

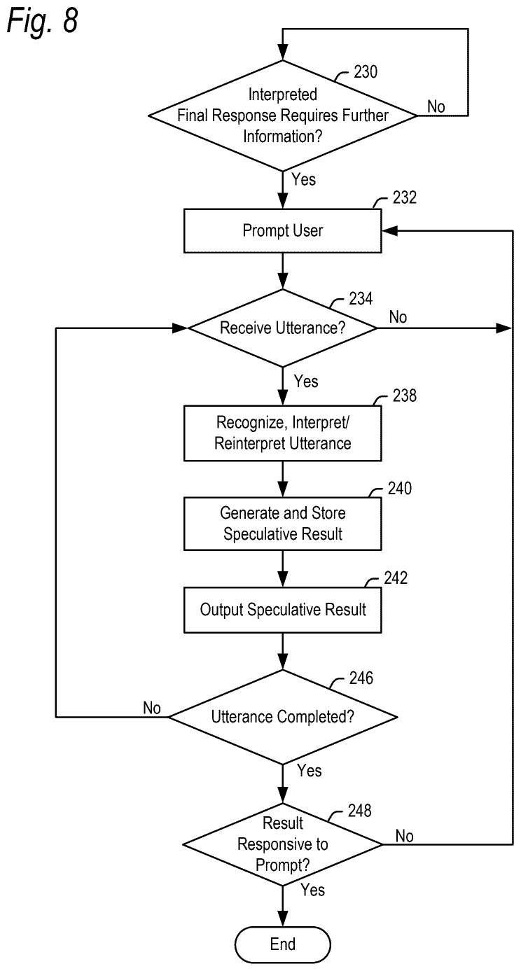

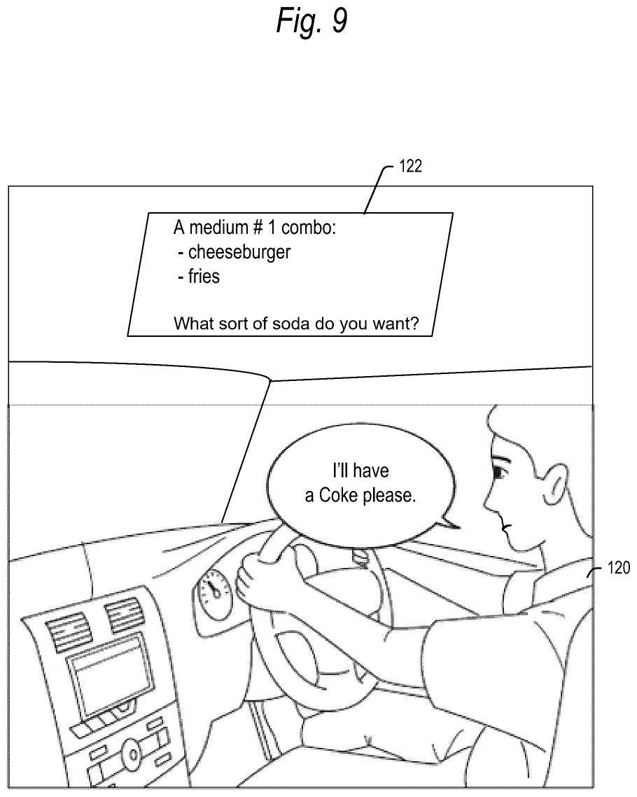

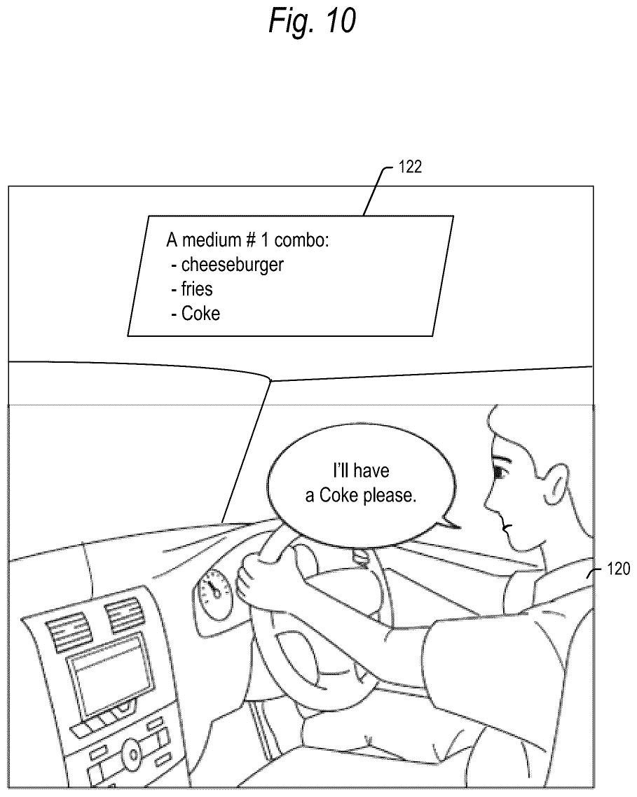

It may happen that a final result may cause a further prompt to be displayed to the user. Such an example will now be described with reference to the flowchart of FIG. 8 and the illustrations of FIGS. 9 and 10. In step 230, the server 102 checks whether a final response requires further information. For example, the speculative execution engine 112 may be trained to analyze final responses to determine whether more information is needed (either by itself or together with GAI engine 132 integrated into processor 104). Thus, continuing with the example of FIGS. 4-7, the server 102 may analyze the user's final order and determine that additional information is needed, for example, what type of soda the user would like.

In step 232 and as shown in FIG. 9, the user may be prompted to provide additional needed information to complete his order. In this example, the user is prompted by the audio/visual device 122 to specify the type of soda. In step 234, the server checks whether a response is received.

Assuming a response is received in step 234, the server 102 recognizes and interprets the response in step 238. These operations may be performed by the ASR and NLU engines 108, 110 as described above. However, at this stage of operation, recognition and/or interpretation of the responses by the ASR engine 108 and/or NLU engine 110 may have more guidance as compared to when initially receiving the user's order. Namely, the ASR and NLU engines may be guided to look for recognitions and/or interpretations that are consistent with the category of the prompt of step 232. Thus, in this example, if the ASR engine 110 comes up with two possibilities, one which is the soda “Coca-Cola” or “Coke” on the one hand, and another which is a word or words that are similar to “Coca-Cola” or “Coke” on the other hand, the ASR engine may reasonably conclude that the user said “Coca-Cola” or “Coke,” as that was the subject of the prompt. The NLU engine 108 may similarly interpret an entity as likely coming from the category of the prompt, in this example, sodas.

In step 240, the speculative execution engine 112 may generate and store a speculative result, and may output the speculative result in step 242. Thus, the OCB 122 in FIG. 10 revises the order to reflect that the user has selected a coke as their soda. The speculative execution engine may operate as described above, outputting intermediate, speculative responses in real time where such responses are recognized, and then re-evaluate, and possibly revise, the responses upon receiving and processing further utterances.

In step 246, the completed utterance engine 114 determines whether the user utterance is complete. If not, the flow returns to step 234 to receive additional speech. If the engine 114 determines that the utterance is complete, the server 102 may determine whether the final response is responsive to the prompt in step 248. This operation may be performed by the speculative execution engine 112, by itself and/or in conjunction with the GAI engine 132 integrated into processor 104. If determined to be not responsive, the flow returns to step 232 and the user is again prompted for the requested clarification. On the other hand, if the received final response is responsive to the prompt in step 248, the operation may end, and the most recent speculative response is treated as the final response. Note, this is an example where the final response modifies an earlier completed final response.

In step 246, the completed utterance engine 114 may operate as described above, for example detecting a pause to determine the utterance is complete. However, in this step, the operation of the completed utterance engine 114 may use the category of the prompt as part of its analysis in determining whether a prompt is complete. Thus, in this example where a user is prompted to provide a type of soda, and the response is a type of soda, the engine 114 may conclude that the user has finished speaking.

FIG. 11 illustrates an exemplary computing system 300 that may be server 102 or other server used to implement an embodiment of the present technology. The computing system 300 of FIG. 11 includes one or more processors 310 and main memory 320. Main memory 320 stores, in part, instructions and data for execution by processor unit 310. Main memory 320 can store the executable code when the computing system 300 is in operation. The computing system 300 of FIG. 11 may further include a mass storage device 330, portable storage medium drive(s) 340, output devices 350, user input devices 360, a display system 370, and other peripheral devices 380.

The components shown in FIG. 11 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a solid state drive, a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage medium drive(s) 340 operate in conjunction with a portable non-volatile storage medium, such as a external hard drive, external SSD or USB stick, to input and output data and code to and from the computing system 300 of FIG. 11. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 11 includes output devices 350. Suitable output devices include speakers, printers, network interfaces, and monitors. Where computing system 300 is part of a mechanical client device, the output device 350 may further include servo controls for motors within the mechanical device.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 11 are those typically found in computing systems that may be suitable for use with embodiments of the present invention and are intended to represent a broad category of such computer components that are well known in the art. Thus, the computing system 300 of FIG. 11 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, MacOS, FreeBSD, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, an SSD, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, one embodiment of the present technology relates to a system for speculative execution of voice recognition of utterances, the system comprising: one or more speculative execution servers comprising one or more processors configured to: transcribe user speech in real-time; generate speculative responses to the transcribed user speech; continuously re-evaluate and update responses as new speech is transcribed; determine utterance completion; and provide a final, non-speculative response to the complete utterance.

In another example, the present technology relates to a method for speculative execution of voice recognition of utterances, the method comprising: (a) receiving user speech in real-time; (b) generating speculative responses to the user speech received in said step (a); (c) continuously re-evaluating and updating responses by said step (b) as new speech is received in said step (a); (d) determining utterance completion; and (e) providing a final, non-speculative response to the complete utterance.

In a further example, the present technology relates to a method of automated order taking at a service provider facility using speculative execution of voice recognition of utterances, the method comprising: (a) receiving an order for goods or services from a user in real-time via a microphone at the service provider facility; (b) generating speculative responses to the user speech received in said step (a); (c) continuously re-evaluating and updating responses by said step (b) as new speech is received in said step (a); (d) displaying speculative responses as they are generated in said step (b) and re-evaluated and updated in said step (c) via a display; (e) determining completion of the order for goods or services; and (f) providing a final, non-speculative order response to the complete utterance.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

We claim:

1. A system for speculative execution of voice recognition of utterances, the system comprising:
one or more speculative execution servers comprising one or more processors configured to:
transcribe user speech;
generate speculative responses to the transcribed user speech;
continuously re-evaluate and update responses as new speech is transcribed;
provide the updated responses;
determine utterance completion; and
provide a final, non-speculative response to the complete utterance.

2. The system of claim 1, wherein the server comprises an automatic speech recognition engine implemented by the one or more processors to recognize and transcribe the utterance.

3. The system of claim 1, wherein the server comprises a natural language unit engine implemented by the one or more processors to discern a meaning of the utterance, wherein the meaning may change as new speech is transcribed.

4. The system of claim 3, further comprising a generative artificial intelligence engine working with the one or more processors and the natural language unit engine to assist in discerning the meaning of the utterance.

5. The system of claim 1, wherein the server comprises a speculative execution engine implemented by the one or more processors to form one or more speculative responses as new speech is received.

6. The system of claim 5, further comprising a generative artificial intelligence engine working with the one or more processors and the speculative response engine to assist in forming the one or more speculative responses.

7. The system of claim 1, wherein the server comprises a completed utterance engine implemented by the one or more processors to determine when the user has completed their utterance.

8. The system of claim 7, further comprising a generative artificial intelligence engine working with the one or more processors and the completed utterance engine to assist in determining when the user has completed their utterance.

9. The system of claim 7, wherein the one or more processors store the speculative responses.

10. The system of claim 9, wherein the most recent stored speculative response is taken as the final, non-speculative response to the complete utterance upon the completed utterance engine determining when the user has completed their utterance.

11. The system of claim 1, wherein the server further comprises an audio/visual device, and wherein the step of providing updated responses and providing the final, non-speculative response comprises the steps of the processor outputting the updated and final responses to the audio/visual device as the updated and final responses are determined.

12. The system of claim 11, wherein the audio/visual device comprises an order confirmation board at a drive-through.

13. A method for speculative execution of voice recognition of utterances, the method comprising:
(a) receiving user speech in real-time;
(b) generating speculative responses to the user speech received in said step (a);
(c) continuously re-evaluating and updating responses by said step (b) as new speech is received in said step (a);
(d) determining utterance completion; and
(e) providing a final, non-speculative response to the complete utterance.

14. The method of claim 13, wherein said step (b) of generating speculative responses comprises the step of processing the speech to discern its meaning and determining an appropriate response to the speech upon discerning its meaning.

15. The method of claim 13, wherein said step (b) of generating speculative responses comprises the step of processing the speech to discern intents and entities in the speech and determining an appropriate response to the speech upon discerning its intents and entities.

16. The method of claim 13, further comprising the step of displaying speculative responses as they are generated in said step (b) and re-evaluated updated in said step (c).

17. The method of claim 13, wherein said step (d) of determining utterance completion comprises at least one of:
evaluating a length of a pause in the speech,
analyzing a cadence of the speech,
analyzing context in which the speech is rendered, and
determining a meaning of the speech.

18. The method of claim 12, further comprising the step of utilizing a generative artificial intelligence engine to assist in at least one of steps (b), (c) and (d).

19. A method of automated order taking at a service provider facility using speculative execution of voice recognition of utterances, the method comprising:
(a) receiving an order for goods or services from a user in real-time via a microphone at the service provider facility;
(b) generating speculative responses to the user speech received in said step (a);
(c) continuously re-evaluating and updating responses by said step (b) as new speech is received in said step (a);
(d) displaying speculative responses as they are generated in said step (b) and re-evaluated and updated in said step (c) via a display;
(e) determining completion of the order for goods or services; and
(f) providing a final, non-speculative order response to the complete utterance.

20. The method of claim 19, wherein said steps (a)-(f) are performed at a drive-through location of the service provider facility.

21. The method of claim 19, wherein said steps (a)-(f) are performed inside of the service provider facility.

22. The method of claim 19, wherein said steps (a)-(f) are performed at a restaurant.

23. The method of claim 22, wherein said step (b) of generating speculative responses to the user speech received in said step (a) comprises the step of generating a confirmation of a food order received up to that time.

24. The method of claim 23, wherein said step (c) of continuously re-evaluating and updating responses comprises the step of revising the confirmation of the food order as new speech is received.

25. The method of claim 23, wherein said step (c) of continuously re-evaluating and updating responses comprises the step of providing a confirmation of adding to, deleting from and/or revising the order of the food order as new speech is received.

26. The method of claim 24, wherein said step (f) of providing a final, non-speculative order response to the complete utterance comprises the step of providing a final food order confirmation upon detecting an end to the food order.
